(19) United States
(12) Patent Application Publication
(10) Pub. No.: US 2022/0193563 A1
(43) Pub. Date: Jun. 23, 2022

(54) CONTROL DEVICE AND PRESENTATION SYSTEM

(71) Applicant: KABUSHIKI KAISHA TOKAI RIKA DENKI SEISAKUSHO, Aichi (JP)

(72) Inventor: Yuji MITSUI, Aichi (JP)

(73) Assignee: KABUSHIKI KAISHA TOKAI RIKA DENKI SEISAKUSHO, Aichi (JP)

(21) Appl. No.: 17/606,208

(22) PCT Filed: Feb. 17, 2020
(86) PCT No.: PCT/JP2020/006063

§ 371 Date: Oct. 25, 2021

(30) Foreign Application Priority Data
May 17, 2019 (JP) 2019-093984

(51) Int. Cl. A63H 3/28; G06F 3/01

(52) U.S. Cl. CPC A63H 3/28; A63H 11/00; G06F 3/016

(57) ABSTRACT

Provided is a control device which includes a control unit that controls a presentation by a presentation unit on the basis of an action of a user with respect to a device including the presentation unit, wherein the device is a predetermined object that shows a reaction to the action of the user, and the control unit causes the presentation unit to present the presentation imitating the reaction of the predetermined object with respect to the action of the user. Also provided is a presentation system which includes a presentation unit that presents a presentation to a user and a control unit that controls the presentation by the presentation unit on the basis of an action of a user with respect to a device including the presentation unit, wherein the device is a predetermined object that shows a reaction to the action of the user.

### TECHNICAL FIELD

The present invention relates to a control device and a presentation system.

### BACKGROUND ART

In recent years, products that show various reactions to a user's actions have been developed. For example, Patent Literature 1 discloses a toy that shows a reaction of restoring to a shape before being grasped after being deformed by a user grasping the toy. By grasping the toy as described above, the user can enjoy the touch sensation and the reaction when the shape is restored.

### CITATION LIST

### Patent Literature

Patent Literature 1: JP 2019-55074A

### SUMMARY OF INVENTION

### Technical Problem

Here, in order to improve the satisfaction of the user who uses the above-mentioned product, it is important to realize a mechanism that makes the user feel that the user wants to touch it.

Therefore, the present invention has been made in view of the above problem, and an object of the present invention is to provide a novel and improved control device and presentation system capable of causing users to continue actions for a longer period of time.

### Solution to Problem

In order to solve the problems, according to an aspect of the present invention, there is provided a control device including a control unit that controls a presentation by a presentation unit on the basis of an action of a user with respect to a device including the presentation unit, wherein the device is a predetermined object that shows a reaction to the action of the user, and the control unit causes the presentation unit to present the presentation imitating the reaction of the predetermined object with respect to the action of the user.

The predetermined object may include a predetermined living thing, and the control unit may cause the presentation unit to present the presentation imitating the reaction of the predetermined living thing with respect to the action of the user.

The control unit may control execution of an operation of prompting continuation of the action when the action of the user is stopped.

The control unit may control the presentation by the presentation unit on the basis of a movement or state of another object other than the predetermined object.

Further, when the movement or state of the other object changes, the control unit may cause the presentation unit to present the presentation indicating a direction in which the other object is located.

The control unit may control the presentation unit so as to realize a presentation of information via the user's tactile sense.

Further, in order to solve the above-mentioned problems, according to another aspect of the present invention, there is provided a presentation system including: a presentation unit that presents a tactile presentation to a user; and a control unit that controls the presentation by the presentation unit on the basis of a touching action of a user with respect to a device including the presentation unit, wherein the device has a shape imitating a predetermined object that shows a physical reaction to the action of the user, and the control unit causes the presentation unit to present the presentation imitating the physical reaction of the predetermined object with respect to the touching action of the user.

### Advantageous Effects of Invention

As described above, according to the present invention, it is possible to cause users to continue actions for a longer period of time.

### BRIEF DESCRIPTION OF DRAWINGS

FIG. 1 is a diagram showing a configuration example of a presentation system according to an embodiment of the present invention.

FIG. 2 is a diagram for explaining the operation of a device having an appearance imitating a cat according to the embodiment.

FIG. 3 is a diagram for explaining control of a tactile presentation based on the movement or state of an object other than a predetermined object according to the embodiment.

### DESCRIPTION OF EMBODIMENTS

Hereinafter, preferred embodiments of the present invention will be described in detail with reference to the accompanying drawings. In the present specification and the drawings, components having substantially the same functional configuration are designated by the same reference numerals, and duplicate description will be omitted.

### 1. Embodiment

### «1.1. Overview»

First, the outline of the present invention will be described. As mentioned above, in recent years, products that show various reactions with respect to user's actions have been developed. An example of the above-mentioned products is the toy disclosed in Patent Literature 1.

The user can enjoy various reactions using the above-mentioned products. Further, according to the above-mentioned products, it is expected that not only can the feeling and reaction be enjoyed, but also it can be expected that there will be an effect of improving the ability to concentrate by continuously performing the touching action with the hands or the like is expected. Furthermore, depending on the situation where they are used, they can be expected to have effects such as maintaining arousal, creating a sense of security, and maintaining or promoting health.

Here, in order to maximize the effects, the user is required to continue the action for a longer period of time. For this purpose, it is important not only to improve the touch sensation but also to realize a reaction that is more interesting to the user.

For this purpose, a control device 20 according to the embodiment of the present invention includes a control unit 210 that controls a presentation by a presentation unit 310 on the basis of a user's action with respect to a device including the presentation unit 310. According to a feature, the device is a predetermined object that shows a reaction to the user's action. According to a feature, the control unit 210 according to the embodiment of the present invention causes the presentation unit 310 to present a presentation imitating the reaction of the predetermined object with respect to the user's action.

Hereinafter, the configuration of the control device 20 and the presentation system having the features will be described in detail.

### «1.2. System Configuration Example»

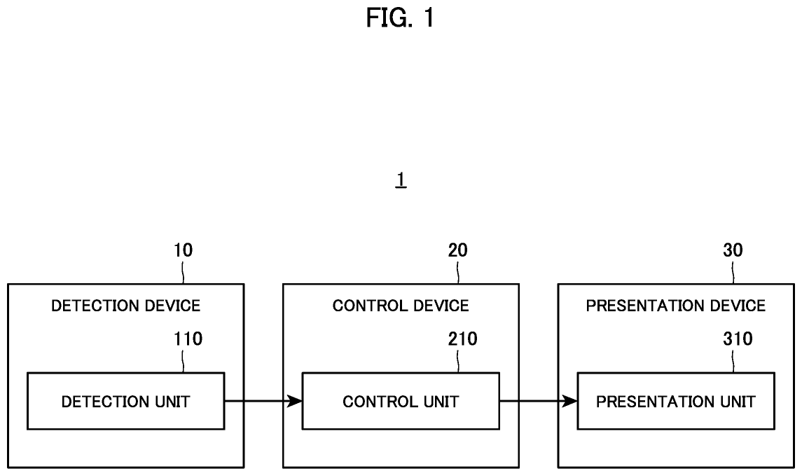

FIG. 1 is a diagram showing a configuration example of a presentation system 1 according to an embodiment of the present invention. As shown in FIG. 1, the presentation system 1 according to the present embodiment includes, for example, a detection device 10, a control device 20, and a presentation device 30.

### (Detection Device 10)

The detection device 10 according to the present embodiment includes a detection unit 110 that detects a user's action. Examples of the above-mentioned action include a touching action. For this purpose, the detection unit 110 according to the present embodiment includes, for example, a capacitance type touch sensor, a pressure sensitive touch sensor, or the like. In addition to the touching action, the above-mentioned action may include, for example, a call.

The detection unit 110 according to the present embodiment may have a function of detecting the movement or state of another object, which will be described later. In this case, the detection unit 110 further includes various sensors for detecting the movement or state of another object. Examples of the sensor include an image sensor, a microphone, various optical sensors including an infrared sensor, a temperature sensor, a vibration sensor, a communication device for receiving information from another object, and the like.

### (Control Device 20)

The control device 20 according to the present embodiment includes the control unit 210 that controls a presentation by the presentation unit 310 on the basis of a user's action with respect to the device including the presentation unit 310 described later. According to a feature, the device (for example, the presentation device 30 described later) including the presentation unit 310 according to the present embodiment is a predetermined object that shows a reaction to the user's action. According to a feature, the control unit 210 according to the present embodiment causes the presentation unit 310 to present a presentation imitating the reaction of the predetermined object with respect to the user's action.

That is, the control unit 210 according to the present embodiment causes the presentation unit 310 to present a presentation that reproduces the action of an object that shows a certain (for example, physical) reaction with respect to the user's actions such as grasping, stroking, and touching.

Here, the reaction refers to a reaction involving a physical quantity that can be sensed by the five senses of the user among some phenomena that occur in response to the user's actions.

For example, when a predetermined object is a cellular cushioning material, the reaction may be a reaction in which a sheet containing air is torn and air leaks to the outside when a pressure equal to or higher than a predetermined pressure is applied by a user's pressing action. In this case, the control unit 210 according to the present embodiment causes the presentation unit 310 to present a presentation imitating the feeling that the sheet is torn or the air leaks to the outside.

Moreover, the predetermined object according to the present embodiment may be a predetermined living thing. At this time, the control unit 210 according to the present embodiment causes the presentation unit 310 to present a presentation imitating the reaction of the predetermined living thing with respect to the user's action.

For example, when the predetermined living thing is a cat, the reaction includes the action of purring when stroked by the user. In this case, the control unit 210 according to the present embodiment causes the presentation unit 310 to present a presentation imitating the feeling of a cat purring. The control unit 210 may cause the presentation unit 310 to present, for example, a vibration imitating the action of a cat snorting.

In this way, the control unit 210 according to the present embodiment controls presentations imitating various reactions of a predetermined object with respect to the user's actions. According to such control, various actions of a predetermined object adopted in the concept can be reproduced, and by attracting more interest of the user, it is possible to cause the user to continue actions for a longer period of time. In this way, various effects such as improvement of the ability to concentrate, maintenance of arousal, creation of a sense of security, and maintenance or promotion of health can be further improved.

The functions of the control unit 210 as shown above can be realized by cooperation of, for example, a processor such as a CPU (Central Processing Unit) or an MCU (Micro Controller Unit), software, and a storage medium such as a ROM (Read Only Memory), or a RAM (Random Access Memory).

### (Presentation Device 30)

The presentation device 30 according to the present embodiment includes a presentation unit 310 that presents to a user on the basis of control of the control unit 210. The presentation unit 310 according to the present embodiment may present various presentations that can be perceived by the user with five senses (visual sense, auditory sense, tactile sense, smell sense, taste sense). The presentation unit 310 according to the present embodiment may present various tactile presentations on the basis of, for example, the control of the control unit 210.

The tactile presentation according to the present embodiment includes, for example, a vibration presentation and a presentation involving various physical quantities that can be sensed by the user with a tactile sense (including a pain sense and a temperature sense). For this purpose, the presentation unit 310 according to the present embodiment includes various mechanisms for presenting tactile presentations imitating the physical reaction performed by a predetermined object that imitates an appearance.

For example, in the case of presenting a vibration presentation, the presentation unit 310 according to the present embodiment may include an eccentric motor (ERM: Eccentric Rotating Mass), a linear vibrator (LRA: Linear Resonant Actuator), a piezo (piezoelectric) element, or the like.

When the predetermined object is a living thing, the presentation unit 310 according to the present embodiment may include various actuators for reproducing the movement of the joints of the living thing.

The presentation unit 310 according to the present embodiment may present various vocal sounds that the user can perceive by hearing on the basis of the control of the control unit 210. The presentation unit 310 according to the present embodiment may output, for example, a vocal sound (for example, a cat's meow) that imitates a reaction involving a sound with respect to a user's action on the basis of the control of the control unit 210. For this purpose, the presentation unit 310 according to the present embodiment includes a speaker, an amplifier, and the like. The presentation unit 310 according to the present embodiment may present a reaction that can be visually perceived by the user.

The configuration example of the presentation system 1 according to the present embodiment has been described above. The configuration described with reference to FIG. 1 is merely an example, and the configuration of the presentation system 1 according to the present embodiment is not limited to such an example. For example, in the above description, a case where the presentation system 1 includes three independent devices has been illustrated, but the detection unit 110, the control unit 210, and the presentation unit 310 according to the present embodiment may be provided in a single device, for example. The configuration of the presentation system 1 according to the present embodiment can be flexibly modified according to specifications and operations.

### «1.3. Application Example»

Next, an application example of the presentation system 1 according to the present embodiment will be described in detail. In the following, a case where a predetermined object according to the present embodiment is a cat and the presentation system 1 according to the present embodiment is realized as a device 90 having an appearance imitating a cat will be described as an example.

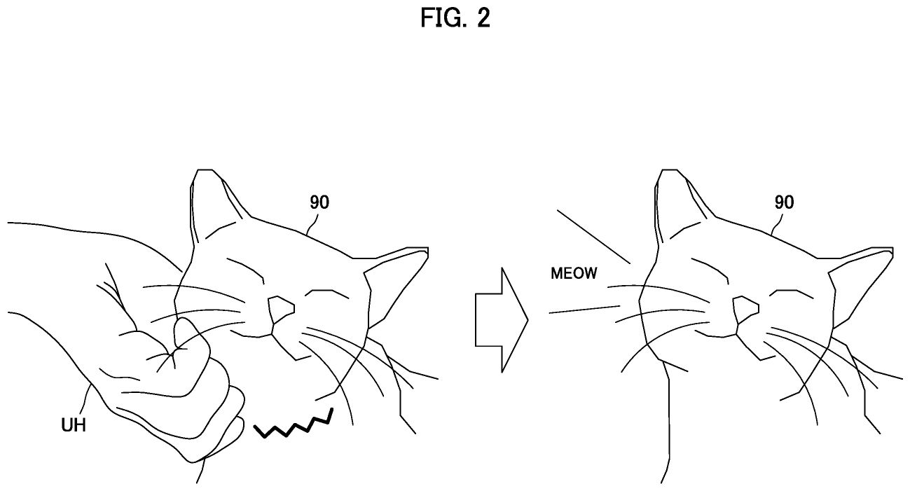

FIG. 2 is a diagram for explaining the operation of the device 90 having an appearance imitating a cat according to the present embodiment. For example, the device 90 according to the present embodiment may have a shape that imitates the head, the neck, the torso, the tail, the feet, and the like. In this case, for example, the user can place the device 90 on the user's lap or the like and perform an action such as stroking the device 90 while watching TV.

For example, the device 90 according to the present embodiment may have only the head and the neck and may be provided in the passenger compartment of a moving body such as a vehicle. At this time, a user other than the driver boarding the moving body can perform an action such as stroking the device 90 when aboard. Further, when the moving body has an automatic driving function, all passengers can perform the above-mentioned actions on the device 90.

On the left side of FIG. 2, a state in which the user is touching the device 90 by using the hand UH in the above-described situation is shown. At this time, the control unit 210 according to the present embodiment may cause the presentation unit 310 to present a tactile presentation on the basis of the detection unit 110 detecting the touching action of the user.

In general, it is known that cats perform an action called purring of making a rumbling sound when they are relieved or happy. Therefore, when the detection unit 110 detects that the user is stroking the device 90, the control unit 210 according to the present embodiment may cause the presentation unit 310 disposed at the portion corresponding to the throat to present a vibration presentation imitating the purring. The control unit 210 may cause the presentation unit 310 to intermittently present low-frequency vibration, for example. At this time, the control unit 210 may cause the presentation unit 310 to present a vocal sound imitating the sound of purring.

According to the above-mentioned control, the user who performs an action on the device 90 senses the vibration similar to the cat's purring with the hand UH, and hears the sound similar to the purring. In this way, the user can feel the feeling such as relief and happiness of the cat by being reminded of that feeling. According to this, the effect of dispelling the anxiety and stress of the user who boards a moving body and the user who performs other tasks such as watching TV, the effect of improving concentration, the effect of suppressing drowsiness (maintaining arousal), and the like can be expected.

The control unit 210 according to the present embodiment may control an operation of causing the user to continue performing actions on the device 90 for a longer period of time. On the right side of FIG. 2, an example of control when the user stops the action on the device 90 is shown.

At this time, the control unit 210 according to the present embodiment may cause the presentation unit 310 to perform an operation imitating an action when an actual cat wants more stroking. For example, the control unit 210 may cause the presentation unit 310 to output a vocal sound imitating the meowing of a cat. For example, the control unit 210 may control the presentation unit 310 so that the head of the device 90 faces the user's face, or may cause the presentation unit 310 to perform an operation such as pressing the head against the hand UH or the like. The control unit 210 may cause the presentation unit 310 to present vibration that imitates the operation performed by the cat when dissatisfied.

As described above, the control unit 210 according to the present embodiment may control the execution of an operation of urging the continuation of the user's action when the action of the user is stopped.

According to the control described above, the user can be caused to hesitate to stop an action with respect to the device 90, and as a result, the action on the device 90 can be continued for a long time. According to this, it is possible to maximize various effects such as creation of a sense of security, maintenance of arousal, and improvement of concentration as described above.

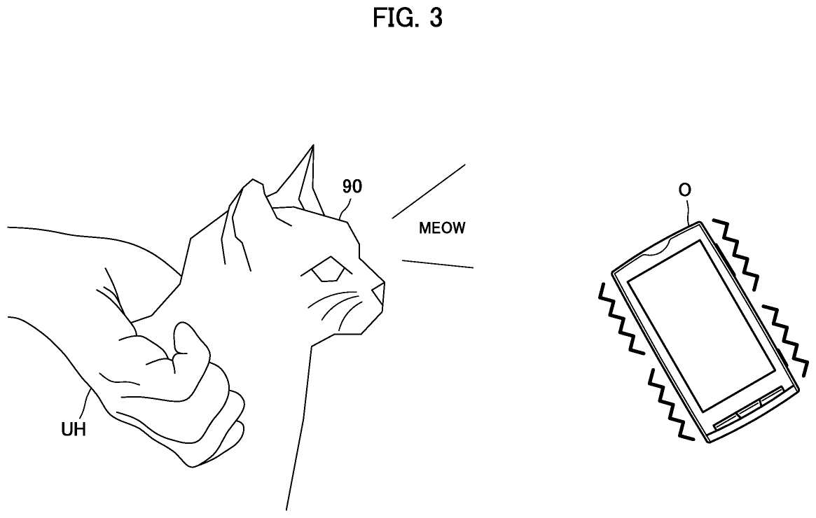

The control unit 210 according to the present embodiment may control the presentation of the presentation unit 310 on the basis of the movement or state of another object other than the device 90. FIG. 3 is a diagram for explaining control of a presentation on the basis of the movement and state of another object other than the predetermined object according to the present embodiment.

FIG. 3 shows the device 90 that the user touches and another object O, which is a smartphone. Here, for example, when the detection unit 110 detects that the other object O vibrates due to an incoming call, an e-mail, or the like, the control unit 210 causes the presentation unit 310 to present a corresponding tactile sense on the basis of the detection of the vibration. The control unit 210 may also cause the presentation unit 310 to output a vocal sound imitating the meowing of a cat.

At this time, the control unit 210 may control the presentation unit 310 so that the head of the device 90 faces in the direction of the other object O, for example, as shown in the figure. In this case, the user perceives that the facing direction of the head has changed due to the change in the feel of the head or whiskers of the device 90 in touching with the hand UH, and further pays his or her attention to the facing direction of the head to notice that the other object O has received some information.

As described above, when the movement or state of the other object changes, the control unit 210 according to the present embodiment may cause the presentation unit 310 to present a presentation indicating the direction in which the other object is located. According to such control, it is possible to increase the likelihood that the user will recognize a change in the movement or state of another object, and the user can respond to the change without missing the change.

A control example in the case where the presentation system 1 according to the present embodiment is realized as the device 90 imitating a cat has been described. As described above, according to the presentation method executed by the presentation system 1 according to the present embodiment, it is possible to cause the user to continue actions for a longer period of time and further enhance various effects such as creation of a sense of security.

An example of the case where the device 90 according to the present embodiment is used while watching TV or aboard a moving body has been illustrated, but the use of the device 90 according to the present embodiment is not limited to such an example. The device 90 according to the present embodiment may be used for medical purposes, for example.

For example, when an elderly person uses the device 90 and continuously performs actions on the device 90, the effects such as maintaining and promoting health and preventing deterioration of memory can be expected. Further, for example, when the device 90 is used for therapy, an effect of reducing anxiety and stress of the user can also be expected.

### «2. Conclusion»

As described above, the control device 20 according to the embodiment of the present invention includes the control unit 210 that controls a presentation by the presentation unit 310 on the basis of a user's action with respect to the device including the presentation unit 310. According to a feature, the device is a predetermined object that shows a reaction to the user's action. According to a feature, the control unit 210 according to the embodiment of the present invention causes the presentation unit 310 to present a presentation imitating the reaction of the predetermined object with respect to the user's action. According to such a configuration, it is possible to cause users to continue actions for a longer period of time.

Although the preferred embodiments of the present invention have been described in detail with reference to the accompanying drawings, the present invention is not limited to such examples. A person skilled in the art may find various alterations and modifications within the scope of the appended claims, and it should be understood that they will naturally come under the technical scope of the present invention.

The effects described in this specification are merely illustrative or exemplified effects, and are not limitative. That is, with or in the place of the effects, the technology according to the present disclosure may achieve other effects that are clear to those skilled in the art based on the description of this specification.

A program for causing hardware such as a CPU, a ROM, and a RAM built into a computer to exhibit functions equivalent to the configuration of the control device 20 can be created, and a computer-readable non-transient recording medium having the program recorded thereon may be also provided.

### REFERENCE SIGNS LIST

1 presentation system
10 detection device
110 detection unit
20 control device
210 control unit
30 tactile presentation device
310 presentation unit

1. A control device comprising a control unit that controls a presentation by a presentation unit on the basis of an action of a user with respect to a device including the presentation unit, wherein
the device is a predetermined object that shows a reaction to the action of the user, and
the control unit causes the presentation unit to present the presentation imitating the reaction of the predetermined object with respect to the action of the user.

2. The control device according to claim 1, wherein
the predetermined object includes a predetermined living thing, and
the control unit causes the presentation unit to present the presentation imitating the reaction of the predetermined living thing with respect to the action of the user.

3. The control device according to claim 2, wherein
the control unit controls execution of an operation of prompting continuation of the action when the action of the user is stopped.

4. The control device according to claim 1, wherein
the control unit controls the presentation by the presentation unit on the basis of a movement or state of another object other than the predetermined object.

5. The control device according to claim 4, wherein
when the movement or the state of the other object changes, the control unit causes the presentation unit to present the presentation indicating a direction in which the other object is located.

6. The control device according to claim 1, wherein
the control unit controls the presentation unit so as to realize a presentation of information via the user's tactile sense.

7. A presentation system comprising:
a presentation unit that presents a presentation to a user; and
a control unit that controls the presentation by the presentation unit on the basis of an action of a user with respect to a device including the presentation unit, wherein
the device is a predetermined object that shows a reaction to the action of the user, and
the control unit causes the presentation unit to present the presentation imitating the reaction of the predetermined object with respect to the action of the user.
